(19) United States
(12) Patent Application Publication
(10) Pub. No.: US 2017/0278130 A1
(43) Pub. Date: Sep. 28, 2017

(54) Method and Electronic Device for Matching Advertisement Data

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Weibo AO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,103

(22) Filed: Aug. 19, 2016

Related U.S. Application Data
(63) Continuation of application No. PCT/CN2016/088479, filed on Jul. 4, 2016.

(30) Foreign Application Priority Data
Mar. 28, 2016 (CN) 201610184169.6

(51) Int. Cl. G06Q 30/02; H04N 21/45; G06K 9/00; H04N 21/258; H04N 21/81; H04N 21/442

(52) U.S. Cl. CPC G06Q 30/0251; H04N 21/812; H04N 21/44218; G06K 9/00268; H04N 21/25883; H04N 21/4532; H04L 67/42

(57) ABSTRACT

The present invention discloses a method and an electronic for matching advertisement data. The method comprises: receiving image data of audiences sent from a client; processing the image data of the audiences to obtain attribute information of the audiences; screening advertisement data matched with the audiences from an advertisement database according to the attribute information of the audiences; and sending the advertisement data matched with the audiences to the client.

### CROSS REFERENCE TO RELATED APPLICATION

The present application is the continuous application of the PCT application PCT/CN2016/088479, filed on Jul. 7, 2016. The present application claims priority to Chinese Patent Application CN201610184169.6 filed with State Intellectual Property Office on Mar. 28, 2016, which is incorporated herein by reference in its entirety.

### TECHNICAL FIELD

The present disclosure relates to the field of data processing technology, and in particular, to a method and an electronic device for matching advertisement data.

### BACKGROUND

As a fully open platform that can be operated conveniently and provide full functions, a smart TV carries an operating system based on traditional TV functions. Based on the carried operating system, a user may install and unload application software by oneself, thereby expanding and upgrading functions of TV, so as to build a TV to be a multimedia terminal characterized in high definition, intelligence and networking.

As an intelligent multimedia terminal, the smart TV has a broadband internet access function, with most of functions to be realized depending on internet. For example, when video playing software installed on the smart TV is being operated, it is required to interact data with a server corresponding thereto via internet, thereby transmitting video data desired to be watched by the user to the smart TV, so that the smart TV can play the corresponding video. Of course, in a same way with playing videos, the smart TV may also obtain advertisement data from an advertisement server when broadcasting the advertisement, thus the advertisement server can randomly select advertisement data within an advertising period.

However, due to a wide usage of the smart TV, audiences that the smart TV faces are different in different periods of time, and due to various types of advertisement, different crowds have different sensitivities to different types of advertisement. For example, adult man has a higher sensitivity to a shaver advertisement than adult woman, while adult woman has a higher sensitivity to a cosmetics advertisement than adult man. It can be seen that, a certain matching accuracy exists in an advertisement for different audiences. Thus, if an advertisement is advertised randomly, its directional matching accuracy will be lowered, and user's experience may further be depressed.

### SUMMARY

In view of this, the embodiments of the present disclosure provide a method and an electronic device for matching advertisement data, which can solve the problem of lowering directional matching accuracy of an advertisement and depressing user's experience due to randomly advertising.

In a first aspect, the embodiments of the present disclosure provide a method for matching advertisement data, including: receiving image data of audiences sent from a client; processing the image data of the audiences to obtain attribute information of the audiences; screening advertisement data matched with the audiences from an advertisement database according to the attribute information of the audiences; and sending the advertisement data matched with the audiences to the client.

In a second aspect, the embodiments of the present disclosure further provide a method for matching advertisement data, including: obtaining image data of audiences; sending the image data of the audiences to an advertisement server; and receiving advertisement data matched with the audiences sent from the advertisement server.

In a third aspect, the embodiments of the present disclosure provide an electronic device, including: at least one processor; and a memory, wherein the memory stores instructions executable by the at least one processor for performing the method for matching advertisement data according to the first aspect of the present disclosure.

In a fourth aspect, the embodiments of the present disclosure provide an electronic device, including: at least one processor; and a memory, wherein the memory stores instructions executable by the at least one processor for performing the method for matching advertisement data according to the second aspect of the present disclosure.

In a fifth aspect, the embodiments of the present disclosure provide a system for matching advertisement data, including: an advertisement server and a client, wherein, the client is configured to obtain image data of audiences, send the image data of the audiences to the advertisement server, and receive advertisement data matched with the audiences sent from the advertisement server; the advertisement server is configured to receive the image data of the audiences sent from the client, process the image data of the audiences to obtain attribute information of the audiences, screen advertisement data matched with the audiences from an advertisement database according to the attribute information of the audiences, and send the advertisement data matched with the audiences to the client.

In a sixth aspect, the embodiments of the present disclosure provide a non-transitory computer storage medium, wherein the computer storage medium may store a program, and when the program is executed, part or all of the steps in respective modes for realizing a method for matching advertisement data provided according to the first aspect of the present disclosure may be realized.

In a seventh aspect, the embodiments of the present disclosure further provide a non-transitory computer storage medium, wherein the computer storage medium may store a program, and when the program is executed, part or all of the steps in respective modes for realizing a method for matching advertisement data provided according to the second aspect of the present disclosure may be realized.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for matching advertisement data provided according to the embodiments of the present disclosure;

FIG. 2 is a flowchart illustrating another method for matching advertisement data provided according to the embodiments of the present disclosure;

FIG. 3 is a schematic diagram of structure illustrating a device for matching advertisement data provided according to the embodiments of the present disclosure;

FIG. 4 is a schematic diagram of structure illustrating another device for matching advertisement data provided according to the embodiments of the present disclosure;

FIG. 5 is a schematic diagram of structure illustrating a system for matching advertisement data provided according to the embodiments of the present disclosure.

FIG. 6 is a schematic diagram of hardware structure illustrating a device for performing the method for matching advertisement data provided according to the embodiments of the present disclosure.

FIG. 7 is a schematic diagram of hardware structure illustrating another device for performing the method for matching advertisement data provided according to the embodiments of the present disclosure

### DETAILED DESCRIPTION

The technical solutions in the embodiments of the present disclosure will be described clearly and fully below in conjunction with the drawings in the embodiments of the present disclosure. Apparently, the embodiments described are only a part of the embodiments of the present disclosure, rather than being the whole embodiments. All the other embodiments obtained by one of ordinary skills in the art based on the embodiments of the present disclosure without creative work pertain to the protection scope of the present disclosure.

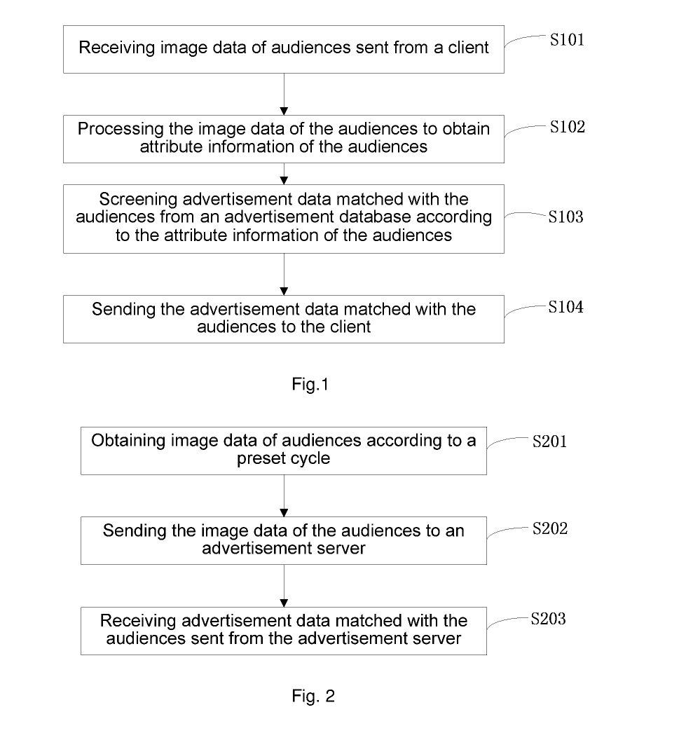

As the technical solutions in the embodiments of the present disclosure mainly lies in directionally matching advertisement data according to audiences, it can be seen that, the main implementing end of the present solution is an advertisement server. Thus, the below embodiments will describe the technical solutions in the embodiments of the present disclosure from the advertisement server end. Referring to FIG. 1, FIG. 1 is a flowchart illustrating a method for matching advertisement data provided according to the embodiments of the present disclosure, including the following steps.

In step S101, image data of audiences sent from a client is received.

At present, with networking of intelligent terminal, an advertisement server may send different advertisement data to different clients at a same time, which may not only raise effective exposure of the advertisement, but also improve user's experience. Specifically, all advertisement data is stored in an advertisement server, wherein each advertisement data can be configured with a matching tag for convenient management, and each matching tag may include information such as region suitable for advertising, genders and ages of the audiences matched, thus can provide basis of screening for directionally matching advertisement data by the advertisement server.

Because genders and ages of the audiences are attribute information of the audiences, the advertisement server may obtain image data of current audiences by the client, and further obtain the attribute information of the audiences by image processing technology, thus can screen advertisement data matched with the audiences according to the attribute information of the audiences.

In step S102, the image data of the audiences is processed to obtain attribute information of the audiences.

Herein, obtaining attributes such as genders and ages of the audiences based on the image data of the audiences usually takes human face as a basis of detection. After face image data is extracted, data of parts such as pupils, canthi, noses and the like in the face image data is correspondingly calculated, respectively, to obtain information of gender and age group of each audience. Therefore, specifically, the advertisement server may firstly extract the face image data from the received image data of the audiences, then calculate the face image data using a first preset algorithm to obtain a first attribute information of the audiences, and calculate the face image data using a second preset algorithm to obtain a second attribute information of the audiences.

Herein, the first attribute information may be gender attribute or age attribute. If the first attribute information is gender attribute, the first preset algorithm is an algorithm for calculating gender attribute, while the second attribute information is then age attribute, the second preset algorithm is an algorithm for calculating age attribute. If the first attribute information is age attribute, the first preset algorithm is an algorithm for calculating age attribute, while the second attribute information is gender attribute, and the second preset algorithm is an algorithm for calculating gender attribute. Of course, the contents described above are merely at least one example, and in the present solution, the first attribute information and the second attribute information may further be other attribute information available for directionally matching advertisement data, which are not a limit in the embodiments of the present disclosure.

It should be noted that, the first preset algorithm and the second preset algorithm are algorithm models for calculating two attributes respectively, and the two algorithm models are obtained by training in use of known image data in advance. Due to different calculating modes and different collected data for training different algorithm models, in the present embodiment, each attribute information corresponds to an algorithm model. If it is required to calculate attributes, such as races, identities, and the like, of the audiences, an algorithm model for calculating races and identities should further be respectively provided in the advertisement server. Furthermore, because the methods and technology of training algorithm models are those acquainted with one of ordinary skills in the art, the embodiment of the present disclosure is not further described in details herein.

Furthermore, the image data of the audiences may include face image data of a plurality of audiences. Herein, when the attribute information of the audiences is calculated by algorithm models, the face image data of each audience may be inputted into the model one by one to calculate each attribute information of the audiences respectively.

As can be known from the description of the present step, according to the present solution, the attribute information of the audiences can be obtained by analyzing the face image data of the audiences, thus can provide technical preparation and necessary matching parameters for directionally matching advertisement data according to audiences.

In step S103, advertisement data matched with the audiences is screened from an advertisement database according to the attribute information of the audiences.

Herein, due to directionally matching advertisement data by the advertisement server according to audiences, after each attribute information of the audiences is obtained by calculating, advertisement data with a matched tag including all attributes of the audiences is selected from the advertisement database. It should be noted that, before advertisement data is matched according to audiences, the advertisement server will usually firstly determine priority levels of the advertisement data to be selected, and then select advertisement data in sequence according to the priority levels ranked from high to low.

Specifically, the advertisement server may read address information of the client in advance, and determine an advertisement data group advertised in a region corresponding to address information according to the address information of the client. To facilitate description, the advertisement data group is called as a first advertisement data group in the present embodiment. If no advertisement data group to be advertised exists in the region corresponding the address information, an advertisement data group to be advertised corresponding to a region adjacent to the region is determined to be the first advertisement data group. Then, an advertisement data group with a matched tag including the first attribute information of all the audiences is searched from the first advertisement data group, and the advertisement data group is called as a second advertisement data group in the present embodiment. After that, an advertisement data group with a matched tag including the second attribute information of all the audiences is searched from the second advertisement data group. In such way the advertisement data group is screened per layer until the last advertisement data group, which then can be determined as an advertisement data matched with the audience group.

For example, a client is a smart TV used in place of Beijing, and currently, the audiences of the smart TV include an aged person, two middle-aged persons and a young person, wherein the aged person and one middle-aged person are women, and the other middle-aged person and the young person are men. In this case, after determining the address is Beijing by IP address (Internet Protocol Address) of the smart TV, the advertisement server determines an advertisement data group advertised in place of Beijing to be a first advertisement data group, and screens an advertisement data group simultaneously matched with men and women from the first advertisement data group as a second advertisement data group; after that screens advertisement data simultaneously matched with three generations of aged, middle-aged and young persons from the second advertisement data group to obtain a third advertisement data group, which is an advertisement data group matched with the audience group in the present embodiment.

Of course, the contents described above are merely a preferred example, and the technical solutions in the embodiments of the present disclosure may further include more attribute information, for example, genders, ages and races. When the attribute information includes genders, ages and races, the process of screening the attribute information is similar with the above mentioned process. Furthermore, the screening sequence is variable, wherein the second advertisement data group can also be firstly obtained conditioned on age attribute, and then the third advertisement data group is obtained conditioned on gender attribute, which are not a limit in the embodiments of the present disclosure.

It should be noted that, in the embodiments of the present disclosure, the third advertisement data group may include a random number of advertisement data, and may not include any advertisement data. If the third advertisement data group includes no advertisement data, advertisement data will not be sent to the client, and no advertisement is advertised at this time; if the third advertisement data group includes one advertisement data, the advertisement data is then determined to be advertisement data to be sent; and if the third advertisement data group includes a plurality of advertisement data, one advertisement data is randomly selected therefrom as advertisement data to be sent.

Furthermore, to improve user's experience, in the present embodiment, after the advertisement data matched with the audience group is obtained, it can further be matched again according to the attributes of the client to obtain advertisement data matched with both the audiences and the client. For example, if the client is a vehicle-carried system, advertisement data associated with vehicles can be further selected.

As can be known from the description of the present step, the advertisement server can screen layer by layer from an advertisement database according to multiple attributes of the audiences, thus can accurately screen the advertisement data matched with the audiences. In this way, the directional matching accuracy of the advertisement data can be dramatically raised, and user's experience can also be improved.

In step S104, the advertisement data matched with the audiences is sent to the client.

Based on the description of the above step, after screening the advertisement data matched with the audiences, the advertisement server sends the screened advertisement data to the client, so that the client can play advertisements corresponding to the advertisement data.

As can be known from the description of the present embodiment, according to the technical solutions in the embodiments of the present disclosure, an advertisement server obtains current attribute information of audiences in advance according to image data of the audiences, then takes the attribute information of the audiences as reference information to select advertisement data matched therewith. Compared with the prior art, directionally matching advertisement data according to audiences can raise directional matching accuracy of the advertisement, and can then improve user's experience.

The above embodiment is described from a view of an advertisement server. To make one of ordinary skills in the art more clearly and exhaustively understand the present solution, the present solution is described from a view of a client as below.

Referring to FIG. 2, FIG. 2 is a flowchart illustrating another method for matching advertisement data provided according to the embodiments of the present disclosure, wherein the method includes the following steps.

In step S201, image data of audiences is obtained according to a preset cycle.

Herein, to improve user's experience, after powered on, the client may photograph images of current audiences via a camera by a certain frequency, and process and analyze image data of the photographed images of the audiences, so that the image data of the audiences can serve as a basis for matching advertisement data by the advertisement server.

In the present embodiment, the preset cycle may be several seconds, specifically, may be set according to different clients, and the embodiment of the present disclosure is not further described in details herein.

Furthermore, it should be noted that, in the present solution, the client may but not be limited to smart TV and vehicle-carried system, and when image data of the audiences is sent to an advertisement server, IP address and attribute information oneself can be sent simultaneously.

In step S202, the image data of the audiences is sent to an advertisement server.

Herein, various cases may exist in current scene, for example, the room where a smart TV is placed is dimly lit, or no audience is currently watching TV programs, and so on, which all will cause a failure of extracting face image data from the obtained image data of the audiences, such that the advertisement server may by no means match the advertisement data. Therefore, the client sends a group of image data of the audiences, where obtaining every time, to the advertisement server, which will consume part of processing resources of the advertisement server.

To solve the above problem, the client may take whether face feature information can be extracted as a preset condition where obtaining a group of image data of the audiences every time, and judge whether face feature data can be extracted from the obtained image data of the audiences. If the face feature data can be extracted from the obtained image data of the audiences, it means the image is clear, and audiences of the advertisement data are existing currently, and in this case the image data of the audiences can be sent to the advertisement server. If the face feature data cannot be extracted from the obtained image data of the audiences, it means the image is unclear or no audience exist currently, and in this case the image data of current audiences can be ignored and new images of audiences can be successively photographed to obtain new image data of the audiences.

After the client sends effective image data of the audiences to the advertisement server, the advertisement server obtains attribute information of the audiences by the image data of the audiences, thus can directionally match advertisement data, which can be specifically referred to the description of the above embodiment, and the embodiment of the present disclosure is not further described in details herein.

As can be known from the present step, after photographing the images of the audiences, the client analyzes image data of the audiences, thus can send the effective image data of the audiences to the advertisement server, so as to improve the availability of the processing resources of the advertisement server, and raise the processing speed of the advertisement server.

In step S203, advertisement data matched with the audiences sent from the advertisement server is received.

Herein, after receiving the advertisement data sent from the advertisement server, the client may play advertisements corresponding to the advertisement data at appropriate time and place.

In summary, it can be known that, according to the method for matching advertisement data provided by the embodiments of the present disclosure, before sending advertisement data to a client, an advertisement server firstly receives image data of audiences sent from the client, and processes the image data of the audiences to obtain attribute information of the audiences; then screens advertisement data matched with audiences from an advertisement database according to the attribute information of the audiences, and sends the advertisement data matched with the audiences to the client. It can be seen that, according to the technical solutions in the embodiments of the present disclosure, an advertisement server obtains current attribute information of audiences in advance according to image data of the audiences, then takes the attribute information of the audiences as reference information to select advertisement data matched therewith. Compared with the prior art, directionally matching advertisement data according to audiences can raise directional matching accuracy of the advertisement, and can then improve user's experience.

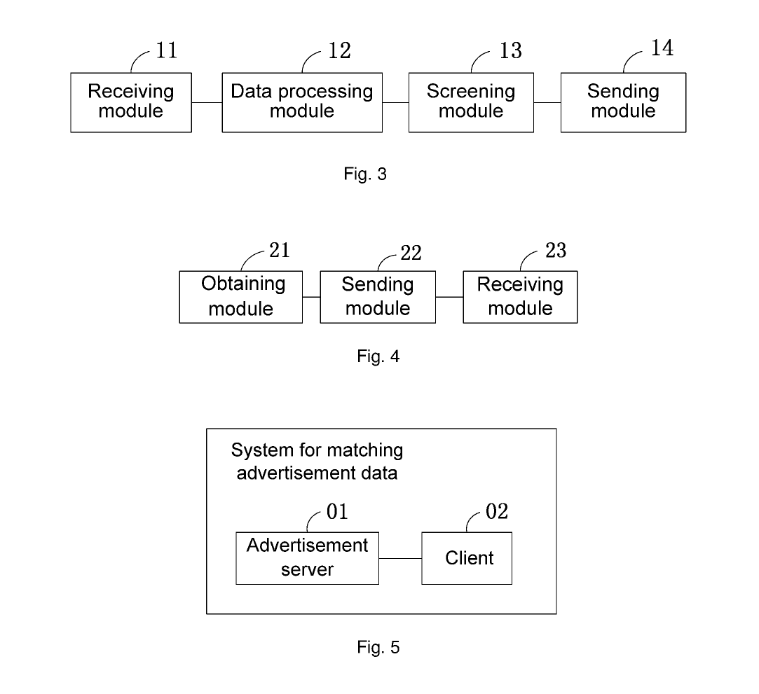

Corresponding to the above realization method, the embodiments of the present disclosure further provide a device for matching advertisement data, and it should be noted that, the present embodiment will describe the device of the advertisement server. Referring to FIG. 3, which is a schematic diagram of structure illustrating a device for matching advertisement data provided according to the embodiments of the present disclosure.

The device includes: a receiving module 11, a data processing module 12, a screening module 13 and a sending module 14, wherein, the receiving module 11 is configured to receive image data of audiences sent from a client; the data processing module 12 is configured to process the image data of the audiences to obtain attribute information of the audiences; the screening module 13 is configured to screen advertisement data matched with the audiences from an advertisement database according to the attribute information of the audiences; and the sending module 14 is configured to send the advertisement data matched with the audiences to the client.

Herein, based on the above embodiment, the data processing module 12 can specifically include: an extracting unit and a calculating unit, wherein, the extracting unit is configured to extract face image data from the image data of the audiences; and the calculating unit is configured to use a first preset algorithm to calculate the face image data to obtain first attribute information of the audiences. In the present embodiment, the calculating unit is further configured to use a second preset algorithm to calculate the face image data to obtain second attribute information of the audiences.

Based on the above descriptions, in another embodiment, the screening module 13 includes a determining unit and a screening unit, wherein, the determining unit is configured to determine a first advertisement data group according to address information corresponding to the client; and the screening unit is configured to screen advertisement data matched with the first attribute information from the first advertisement data group to obtain a second advertisement data group. In the present embodiment, the screening unit is further configured to screen advertisement data matched with the second attribute information from the second advertisement data group to obtain a third advertisement data group; and the determining unit is further configured to determine advertisement data matched with the audiences from the third advertisement data group.

The process of realizing the functions and effects of respective module and unit in the device can be referred to the process of realization corresponding to the above methods in details, without being further described in details herein.

It can be seen that, according to the technical solutions in the embodiments of the present disclosure, an advertisement server obtains current attribute information of audiences in advance according to image data of the audiences, then takes the attribute information of the audiences as reference information to select advertisement data matched therewith. Compared with the prior art, directionally matching advertisement data according to audiences can raise directional matching accuracy of the advertisement, and can then improve user's experience

Of course, to make one of ordinary skills in the art more clearly and exhaustively understand the present solution, the embodiments of the present disclosure further describe from a view of a client. Referring to FIG. 4, which is a schematic diagram of structure illustrating another device for matching advertisement data provided according to the embodiments of the present disclosure. The device including: an obtaining module 21, a sending module 22 and a receiving module 23, wherein, the obtaining module 21 is configured to obtain image data of audiences; the sending module 22 is configured to send the image data of the audiences to an advertisement server; and the receiving module 23 is configured to receive advertisement data matched with the audiences sent from the advertisement server.

Herein, based on the present embodiment, the device further includes a judging module, configured to judge whether face feature data can be extracted from the image data of the audiences. In the present embodiment, the sending module is further configured to send the image data of the audiences to the server when the face feature data can be extracted from the image data of the audiences; and the obtaining module is further configured to obtain image data of audiences according to a preset cycle when the face feature data cannot be extracted from the image data of the audiences.

The process of realizing the functions and effects of respective module and unit in the device can be referred to the realization process corresponding to the above methods in details, without being further described in details herein.

Furthermore, corresponding to the above realization method and device, the embodiments of the present disclosure further provide a system for matching advertisement data. Referring to FIG. 5, which is a schematic diagram of structure illustrating a system for matching advertisement data provided according to the embodiments of the present disclosure. The system includes an advertisement server 01 and a client 02, wherein, the client 02 is configured to obtain image data of audiences, send the image data of the audiences to the advertisement server 01, and receive advertisement data matched with the audiences sent from the advertisement server 01; and the advertisement server 01 is configured to receive the image data of the audiences sent from the client 02, process the image data of the audiences to obtain attribute information of the audiences, screen advertisement data matched with the audiences from an advertisement database according to the attribute information of the audiences, and send the advertisement data matched with the audiences to the client 02.

It should be noted that, the specific process of executing the advertisement server 01 and the client 02 is referred to the descriptions of the above embodiment in details, and the embodiment of the present disclosure is not further described in details herein.

Furthermore, the client 02 may but not be limited to equipment such as smart mobile phone, vehicle-carried system, smart TV, and the like, which are not a limit in the embodiments of the present disclosure.

It should be noted that, the embodiments of the present disclosure further provide a non-transitory computer storage medium set in an advertisement server, wherein the computer storage medium may store a program, and when the program is executed, part or all of the steps in respective modes for realizing a method for matching advertisement data provided according to the embodiment shown in FIG. 1 may be realized.

In another embodiment, the embodiment of the present disclosure further provides another non-transitory computer storage medium set in a client, wherein the computer storage medium may store a program, and when the program is executed, part or all of the steps in respective modes for realizing a method for matching advertisement data provided according to the embodiment shown in FIG. 2 may be realized.

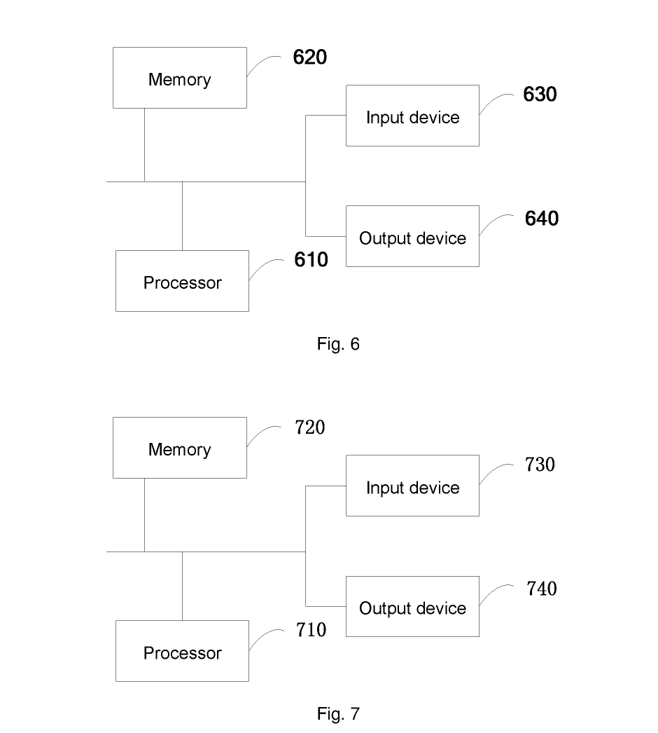

FIG. 6 is a schematic diagram of hardware structure illustrating a device for performing the method for matching advertisement data provided according to the embodiments of the present disclosure. The device is applied to a server. As shown in FIG. 6, the device includes one or more processor 610 and a memory 620. In FIG. 6, only one processor 610 is shown as an example.

The device for performing the method for matching advertisement data may further include an input device 630 and an output device 640.

The processor 610, the memory 620, the input device 630 and the output device 640 may be connected by bus or other means. FIG. 6 shows the devices are connected by bus as an example.

The memory 620 is a non-transitory computer-readable storage medium, which may be used to store non-transitory software program, non-transitory computer-executable program and module, such as the program instruction/module corresponding to the method for matching advertisement data of the embodiments of the present disclosure. The processor 610 may perform various functions and applications of the server and process data by running the non-transitory software program, instructions and module stored in the memory 620, so as to realize the method for matching advertisement data of the embodiments aforementioned.

The memory 620 may include a program storage area and a data storage area, wherein the program storage area may store an operation system and an application program for achieving at least one function; the data storage area may store data established according to the use of the device for matching advertisement data. In addition, the memory 620 may include a high-speed random access memory, and may further include a non-transitory memory, such as at least one of magnetic disk memory, flash memory or other non-volatile solid state memory. In some examples, the memory 620 may preferably include memories set remotely with respect to the processor 610, wherein these remote memories may be connected to the device for matching advertisement data via the network. The examples of the network include but are not limited to internet, intranet, local area network (LAN), mobile communication network and their combinations.

The input device 630 may receive the information of a number or a character as inputted, and generate key input signals relating to the user setting and function control of the device for matching advertisement data. The output device 640 may include a display device such as a display screen.

The one or more modules are stored in the memory 620. When the one or more modules are executed by one or more processors 610, the method for matching advertisement data according to any of the above embodiments in the server side are executed.

The above product may execute the method provided by the embodiments of the present disclosure, and has the corresponding functional module for executing the method, and therefore has beneficial effect. For the details that are not fully described in this embodiment, please refer to the methods provided by the embodiments of the present disclosure.

FIG. 7 is a schematic diagram of hardware structure illustrating another device for performing the method for matching advertisement data provided according to the embodiments of the present disclosure. The device is applied to a client. As shown in FIG. 7, the device includes one or more processor 710 and a memory 720. In FIG. 7, only one processor 710 is shown as an example.

The device for performing the method for matching advertisement data may further include an input device 730 and an output device 740.

The processor 710, the memory 720, the input device 730 and the output device 740 may be connected by bus or other means. FIG. 7 shows the devices are connected by bus as an example.

The memory 720 is a non-transitory computer-readable storage medium, which may be used to store non-transitory software program, non-transitory computer-executable program and module, such as the program instruction/module corresponding to the method for matching advertisement data of the embodiments of the present disclosure. The processor 710 may perform various functions and applications of the server and process data by running the non-transitory software program, instructions and module stored in the memory 720, so as to realize the method for matching advertisement data of the embodiments aforementioned.

The memory 720 may include a program storage area and a data storage area, wherein the program storage area may store an operation system and an application program for achieving at least one function; the data storage area may store data established according to the use of the device for matching advertisement data. In addition, the memory 720 may include a high-speed random access memory, and may further include a non-transitory memory, such as at least one of magnetic disk memory, flash memory or other non-volatile solid state memory. In some examples, the memory 720 may preferably include memories set remotely with respect to the processor 710, wherein these remote memories may be connected to the device for matching advertisement data via the network. The examples of the network include but are not limited to internet, intranet, local area network (LAN), mobile communication network and their combinations.

The input device 730 may receive the information of a number or a character as inputted, and generate key input signals relating to the user setting and function control of the device for matching advertisement data. The output device 740 may include a display device such as a display screen.

The one or more modules are stored in the memory 720. When the one or more modules are executed by one or more processors 710, the method for matching advertisement data according to any of the above embodiments in the client side are executed.

The above product may execute the method provided by the embodiments of the present disclosure, and has the corresponding functional module for executing the method, and therefore has beneficial effect. For the details that are not fully described in this embodiment, please refer to the methods provided by the embodiments of the present disclosure.

The electronic device in embodiments of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculating and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console, E-book and smart toys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned embodiments for the device are merely illustrative, wherein the unit illustrated as a separated component may be or may not be physically separated, the component illustrated as a unit may be or may not be a physical unit, in other words, may be either disposed in a same place or distributed to a plurality of network units. All or part of modules may be selected as actually required to realize the objects of the present disclosure.

According to the description of the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to perform the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for matching advertisement data, which is applied to a server, comprising:
receiving image data of audiences sent from a client;
processing the image data of the audiences to obtain attribute information of the audiences;
screening advertisement data matched with the audiences from an advertisement database according to the attribute information of the audiences; and
sending the advertisement data matched with the audiences to the client.

2. The method for matching advertisement data according to claim 1, wherein, the step of processing the image data of the audiences to obtain attribute information of the audiences comprises:
extracting face image data from the image data of the audiences;
using a first preset algorithm to calculate the face image data to obtain first attribute information of the audiences; and using a second preset algorithm to calculate the face image data to obtain second attribute information of the audiences.

3. The method for matching advertisement data according to claim 2, wherein, the step of screening advertisement data matched with the audiences from an advertisement database according to the attribute information of the audiences comprises:
determining a first advertisement data group according to address information corresponding to the client;
screening advertisement data matched with the first attribute information from the first advertisement data group to obtain a second advertisement data group;
screening advertisement data matched with the second attribute information from the second advertisement data group to obtain a third advertisement data group; and
determining advertisement data matched with the audiences from the third advertisement data group.

4. A non-transitory computer storage medium storing computer-executable instructions configured to:
receive image data of audiences sent from a client;
process the image data of the audiences to obtain attribute information of the audiences;
screen advertisement data matched with the audiences from an advertisement database according to the attribute information of the audiences; and
send the advertisement data matched with the audiences to the client.

5. The non-transitory computer storage medium according to claim 4, wherein the step of processing the image data of the audiences to obtain attribute information of the audiences comprises:
extracting face image data from the image data of the audiences;
using a first preset algorithm to calculate the face image data to obtain first attribute information of the audiences; and using a second preset algorithm to calculate the face image data to obtain second attribute information of the audiences.

6. The non-transitory computer storage medium according to claim 4, wherein the step of screening advertisement data matched with the audiences from an advertisement database according to the attribute information of the audiences comprises:
determining a first advertisement data group according to address information corresponding to the client;
screening advertisement data matched with the first attribute information from the first advertisement data group to obtain a second advertisement data group;
screening advertisement data matched with the second attribute information from the second advertisement data group to obtain a third advertisement data group; and
determining advertisement data matched with the audiences from the third advertisement data group.

7. An electronic device, comprising:
at least one processor; and
a memory, communicably connected with the at least one processor; wherein
the memory stores instructions executable by the at least one processor, and execution of the instructions by the at least one processor causes the at least one processor to:
receive image data of audiences sent from a client;
process the image data of the audiences to obtain attribute information of the audiences;
screen advertisement data matched with the audiences from an advertisement database according to the attribute information of the audiences; and
send the advertisement data matched with the audiences to the client.

8. The electronic device according to claim 7, wherein the step of processing the image data of the audiences to obtain attribute information of the audiences comprises:
extracting face image data from the image data of the audiences;
using a first preset algorithm to calculate the face image data to obtain first attribute information of the audiences; and using a second preset algorithm to calculate the face image data to obtain second attribute information of the audiences.

9. The electronic device according to claim 7, wherein the step of screening advertisement data matched with the audiences from an advertisement database according to the attribute information of the audiences comprises:
determining a first advertisement data group according to address information corresponding to the client;
screening advertisement data matched with the first attribute information from the first advertisement data group to obtain a second advertisement data group;
screening advertisement data matched with the second attribute information from the second advertisement data group to obtain a third advertisement data group; and
determining advertisement data matched with the audiences from the third advertisement data group.
